(19) United States
(12) Patent Application Publication
(10) Pub. No.: US 2026/0004530 A1
(43) Pub. Date: Jan. 1, 2026

(54) COARSE-TO-FINE FUSION METHOD AND APPARATUS FOR VIRTUAL SPACE NAVIGATION BASED ON LANGUAGE COMMANDS

(71) Applicant: INDUSTRY ACADEMY COOPERATION FOUNDATION OF SEJONG UNIVERSITY, SEOUL (KR)

(72) Inventors: Yong Guk KIM, Seongnam-si (KR); Soo Mi CHOI, Seoul (KR); Anh Hoang Vo, Seoul (KR); Thanh Tin Nguyen, Auburn, AL (US)

(21) Appl. No.: 18/938,183

(22) Filed: Nov. 5, 2024

(30) Foreign Application Priority Data
Jul. 1, 2024 (KR) 10-2024-0086334

(51) Int. Cl. G06T 19/00; A63F 13/5375; G06F 40/289

(52) U.S. Cl. CPC G06T 19/003; G06F 40/289; A63F 13/5375

(57) ABSTRACT

Disclosed are a coarse-to-fine fusion method and apparatus for virtual space navigation based on language commands. The coarse-to-fine fusion method for virtual space navigation based on language commands includes: (a) applying an input image to an encoder to extract first to nth visual feature maps having a hierarchical structure; (b) applying an instruction having a length of N to a language model to extract a text feature map; and (c) fusing each of the first to nth visual feature maps with the text feature map to generate an attention map.

### CROSS-REFERENCE TO RELATED APPLICATION

This application claims the benefit of priority under 35 U.S.C. § 119 (a) to Korean Patent Application No. 10-2024-0086334 filed on Jul. 1, 2024, the entire contents of which are incorporated herein by reference.

### BACKGROUND

### (a) Technical Field

The present disclosure relates to a coarse-to-fine fusion method and apparatus for virtual space navigation based on language commands.

### (b) Background Art

When trying to reach a target point in a 3D maze, an agent should train a policy that maximizes a reward function which is an incentive that notifies correct and incorrect actions. The reward function maps each perceived state of an environment to numbers to specify intrinsic desirability of the corresponding state.

However, it is difficult to create a correct mapping according to the given process. To solve this problem, it is more convenient to use language or text to instruct the agent if possible. However, since the instructions using the language or text include a visual description of the environment, it is difficult to understand spatial relationships in the text.

Language grounding is a research field in which the agent understands the meaning of the given instruction. The language grounding is an essential task for an exploring robot that receives commands in the form of spoken language, which is known as a vision language navigation (VLN) problem. Reinforcement learning has been preferred to process the VLN in a game environment. The VLN in the real environment has attracted much attention in the artificial intelligence community due to its potential applications. Recent studies have utilized both imitation learning (IL) and reinforcement learning (RL) to improve the performance of the agent. In the IL, teacher forcing has been used to train the agent, and in the RL, online policy learning has been used. Nevertheless, exploring a target in a 3D environment following given instructions is a very difficult problem.

### SUMMARY OF THE DISCLOSURE

The present disclosure provides a coarse-to-fine fusion method and apparatus for virtual space navigation based on language commands.

In addition, the present disclosure provides a coarse-to-fine fusion method and apparatus for virtual space navigation based on language commands capable of effectively fusing image and language inputs to navigate a target based on language commands while avoiding objects in a 3D game environment or a virtual indoor environment.

In addition, the present disclosure provides a coarse-to-fine fusion method and apparatus for virtual space navigation based on language commands capable of improving virtual space navigation performance by utilizing visual clues in different visual feature maps and fusing these visual clues with text features.

According to an aspect of the present disclosure, there is provided a coarse-to-fine fusion method for virtual space navigation based on language commands.

According to an embodiment of the present disclosure, there may be provided a coarse-to-fine fusion method for virtual space navigation based on language commands, including: (a) applying an input image to an encoder to extract first to nth visual feature maps having a hierarchical structure; (b) applying an instruction having a length of N to a language model to extract a text feature map; and (c) fusing each of the first to nth visual feature maps with the text feature map to generate an attention map.

The step (b) may include: (b1) reconstructing sizes of the first to nth visual feature maps to be the same; (b2) performing a convolution operation on the reconstructed first to nth visual feature maps with the text feature map, respectively, to generate first to nth attention maps, respectively, and aggregating the first to nth attention maps to generate a step attention map; and (b3) performing the steps (b1) to (b2) multiple times to generate a plurality of the step attention maps, and combining the plurality of step attention maps to generate a final attention map.

Before performing the convolution operation on each of the reconstructed first to nth visual feature maps with the text feature map, the text feature map may be reconstructed to the size of the visual feature map to which the convolution operation is to be applied by applying a fully connected layer.

The coarse-to-fine fusion method may further include: passing the final attention map through two convolutional layers, applying the LSTM model, and then combining time-step embedding to generate a final feature map; and training a reinforcement learning model by applying a state of the final feature map and the text feature map as input to the reinforcement learning model to generate an output action according to the instruction.

According to another aspect of the present disclosure, there is provided an apparatus for performing a coarse-to-fine fusion method for virtual space navigation based on language commands.

According to another embodiment of the present disclosure, there may be provided a computing device, including: a first feature extraction module that applies an input image to an encoder to extract first to nth visual feature maps having a hierarchical structure; a second feature extraction module that applies an instruction having a length of N to a language model to extract a text feature map; and a fusion module that fuses each of the first to nth visual feature maps with the text feature map to generate an attention map.

The fusion module may reconstruct sizes of the first to nth visual feature maps to be the same, perform a convolution operation on the reconstructed first to nth visual feature maps with a text feature map, respectively, to generate first to nth attention maps, respectively, and aggregate the first to nth attention maps to generate a step attention map, wherein a plurality of the step attention maps may be generated, and combined the plurality of step attention maps to generate a final attention map.

The first feature extraction module may further include a decoder used only in a training process, and a loss function of the encoder may be calculated using a mean square error between an output of the decoder and the input image.

Two 3×3 convolution layers and an LSTM (Long Short-Term Memory) model may be located at a rear end of the fusion module, and the final attention map may pass through the two 3×3 convolution layers, pass through the LSTM model, and then may be combined with the time-step embedding to generate a final map.

The computing device may further include a policy learning unit that trains the reinforcement learning model by inputting and applying a state of the final map and the text feature map to a reinforcement learning model to generate an output action according to the instruction.

According to the coarse-to-fine fusion method and apparatus for virtual space navigation based on language commands of an embodiment of the present disclosure, it is possible to effectively fuse the image and language inputs to navigate the target based on the language commands while avoiding the object in the 3D game environment or the virtual indoor environment.

That is, according to the present disclosure, it is possible to improve the virtual space navigation performance by utilizing the visual clues in different visual feature maps and fusing these virtual clues with the text features.

### BRIEF DESCRIPTION OF THE DRAWINGS

FIG. 1 is a diagram schematically illustrating an internal configuration of a computing device for coarse-to-fine fusion for virtual space navigation based on language commands according to an embodiment of the present disclosure.

FIG. 2 and FIG. 3 are diagrams illustrating a detailed configuration of a first feature extraction module according to an embodiment of the present disclosure.

FIG. 4 is a diagram illustrating a detailed configuration of a fusion module according to an embodiment of the present disclosure.

FIG. 5 is a diagram illustrating a pseudocode illustrating a learning algorithm of a first feature extraction module according to an embodiment of the present disclosure.

FIG. 6 is a diagram illustrating a pseudocode illustrating an entire learning algorithm according to an embodiment of the present disclosure.

FIG. 7 and FIG. 8 are diagrams illustrating the overall architecture according to an embodiment of the present disclosure.

FIG. 9 is a diagram illustrating an attention map overlapping on an input image while an agent performs language-based commands according to an embodiment of the present disclosure.

FIG. 10 is a flowchart illustrating a coarse-to-fine fusion method for virtual space navigation based on language commands according to an embodiment of the present disclosure.

### DETAILED DESCRIPTION

Singular forms as used herein include plural forms unless the context clearly indicates otherwise. The term “including”, “include', or the like, as used herein is not to be construed as necessarily including all of several components or several steps described herein, and it is to be construed that some of these components or steps may not be included or additional components or steps may be further included. In addition, the terms “. . . unit”, “module”, and the like, as used herein refer to a processing unit of at least one function or operation and may be implemented as hardware or software or a combination of hardware and software.

Hereinafter, embodiments of the present disclosure will be described in detail with reference to the accompanying drawings.

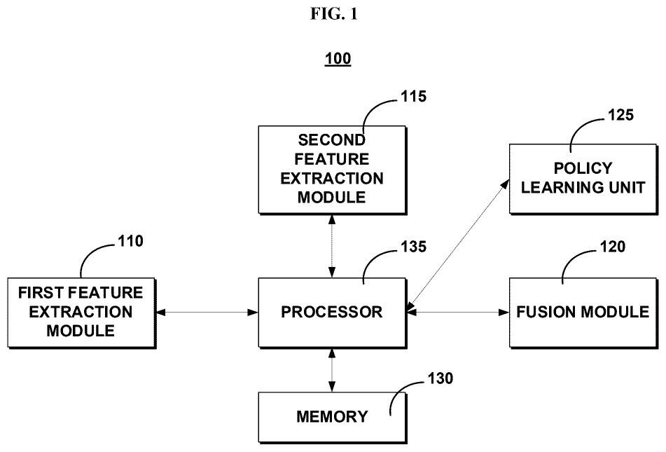

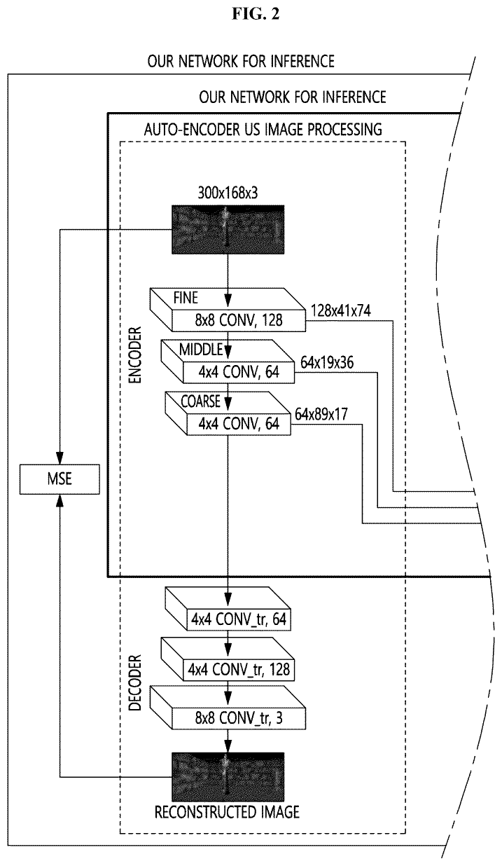

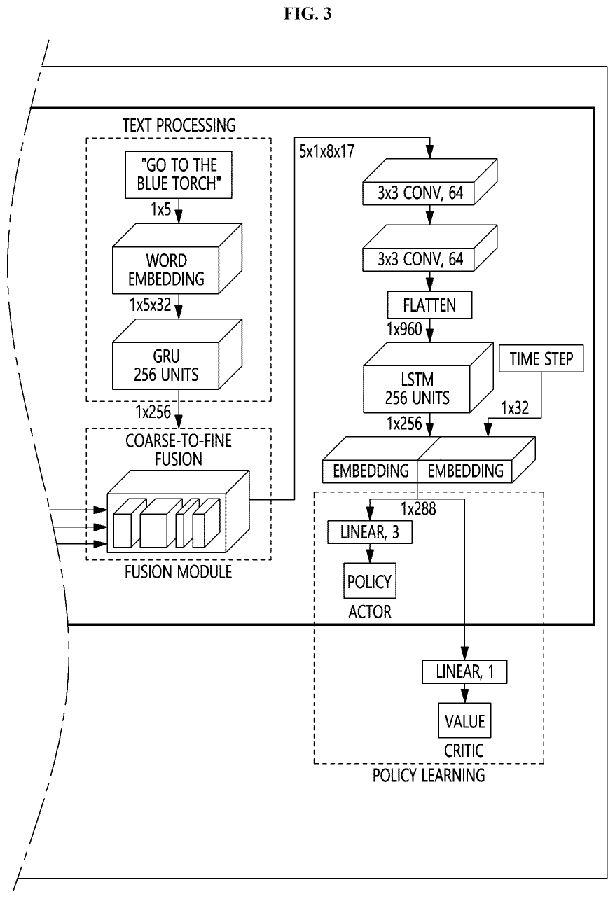

FIG. 1 is a diagram schematically illustrating an internal configuration of a computing device for coarse-to-fine fusion for virtual space navigation based on language commands according to an embodiment of the present disclosure, and FIG. 2 and FIG. 3 are diagrams illustrating a detailed configuration of a first feature extraction module according to an embodiment of the present disclosure.

Referring to FIG. 1, a computing device 100 according to an embodiment of the present disclosure is configured to include a first feature extraction module 110, a second feature extraction module 115, a fusion module 120, a policy learning unit 125, a memory 130, and a processor 135.

The first feature extraction module 110 is a means for extracting a visual feature map for an image.

The first feature extraction module 110 may be a feature pyramid network (FPN) model. Therefore, the first feature extraction module 110 may extract a visual feature map of a hierarchical structure having different resolutions. In an embodiment of the present disclosure, for the convenience of understanding and description, it is described under the assumption that three visual feature maps are extracted, such as a first visual feature map, a second visual feature map, and a third visual feature map.

As illustrated in FIG. 2 and FIG. 3, the first feature extraction module 110 may have an encoder and a decoder. The encoder may extract three visual feature maps with different resolutions using three convolution layers. Referring to FIG. 2 and FIG. 3, for example, assuming that a first convolution layer has a size of 8×8, the number of filters is 128, the number of strides is 7, and there is no padding, applying a 300×168×3 images to the first convolution layer may generate a first visual feature map having a size of 128×41×74.

In addition, assuming that a second convolution layer has a size of 4×4, the number of filters is 64, the number of strides is 2, and there is no padding, applying the second convolution layer to the first visual feature map may generate a second visual feature map having a size of 64×19×36.

In addition, assuming that a third convolution layer has a size of 4×4, the number of filters is 64, the number of strides is 2, and there is no padding, applying the third convolution layer to the second visual feature map may generate a third visual feature map having a size of 64×8×17.

In this way, the first feature extraction module 110 may generate a plurality of visual feature maps having a hierarchical structure by applying a plurality of convolutional layers to an image.

This is shown as in Equation 1.

$${υ}_{image} = [ {υ}_{image}^{coarse} , {υ}_{image}^{middle} , {υ}_{image}^{fine} ] = CNN ( {I}_{image} ) \qquad [ Equation 1 ]$$

Here,

$${υ}_{image}^{fine}$$

represents the first visual feature map,

$${υ}_{image}^{middle}$$

represents the second visual feature map, and

$${υ}_{image}^{coarse}$$

represents the third visual feature map.

The decoder is used only during the training process and may not be used after the training is completed. Like the encoder, the decoder has three convolutional layers and is a means for generating a restored image using the same.

A mean square error (MSE) between the output of the decoder and the input image is calculated, and thus, may be used for training the encoder.

The second feature extraction module 115 has a large language model (LLM), and is a means for extracting a text feature map for an instruction having a length of N using the corresponding language model. Here, the large language model may be BERT, T5, LSTM, GRU, etc. In an embodiment of the present disclosure, it is assumed that the large language model is a GRU-based model, which will be mainly described. In addition, however, when the large language model is a published language model, it may be applied without limitation.

The second feature extraction module 115 may extract sentence vectors (text feature maps) by word embedding each word of the instruction having a length of N as illustrated in FIG. 2 and FIG. 3, and applying the embedded words to a GRU model. This is shown as in Equations 2 and 3.

$${I}_{text} = [ {q}_{t}^{0} \cdot {q}_{t}^{1} , {q}_{t}^{2} … {q}_{t}^{N} ] \qquad [ Equation 2 ]$$

$${h}_{t} = GRU ( {I}_{text} ) \qquad [ Equation 3 ]$$

Here, i ∈1, 2, . . . , N, t∈1, 2, . . . , T, and

$${q}_{t}^{i}$$

and hₜ represent an i-th word embedding in the instruction and a hidden vector at a time step t, respectively.

The vector representation for the instruction is a hidden vector at the last time step, and may be represented as vₜₑₓₜ=h_{T}. In an embodiment of the present disclosure, it is assumed that the size of the sentence vector is 256 dimensions.

The fusion module 120 is a means for fusing the output of the first feature extraction module 110 and the output of the second feature extraction module 115.

The fusion module 120 may treat the text feature map as a filter and apply a convolution operation on the visual feature map to generate a fused attention feature map.

To this end, the fusion module 120 may adjust the plurality of visual feature maps to the same size, and each adjusted visual feature map may be convolved with the plurality of text feature maps to generate an attention map.

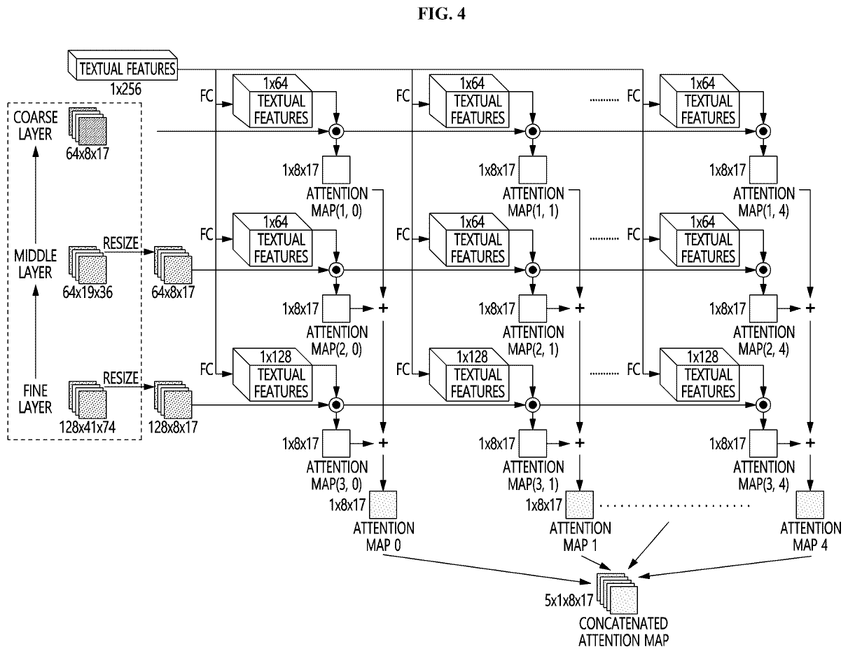

This will be described in more detail with reference to FIG. 4.

First, the fusion module 120 may adjust the first visual feature map and the second visual feature map to the same size as the third visual feature map.

This is shown as in Equations 4 and 5.

$${υ}_{image}^{middle} = Resize ( {υ}_{image}^{middle} , ( W , H ) ) \qquad [ Equation 4 ]$$

$${υ}_{image}^{fine} = Resize ( {υ}_{image}^{fine} , ( W , H ) ) \qquad [ Equation 5 ]$$

Next, the fusion module 120 convolves each visual feature map and text feature map to generate the attention map. That is, a first attention map may be generated by convolving the adjusted first visual feature map and the text feature map, a second attention map may be generated by convolving the adjusted second visual feature map and the text feature map, and a third attention map may be generated by convolving the third visual feature map and the text feature map.

The fusion module 120 may sum the first to third attention maps to generate a final attention map. When convolving the visual feature map and the text feature map, the vector of the text feature map should be projected in 256 dimensions to the same number of channels as the number of convolution layers. The process may be repeated multiple times to generate a plurality of different attention maps, and connect these attention maps to generate a final feature map. For example, when the process is repeated 5 times, the final feature map may be generated to have a size of 5×1×W×H. Here, W represents a width and H represents a height.

As illustrated in FIG. 4, the text feature map may be passed through a fully connected layer.

This is shown as in Equations 6 to 8.

$${υ}_{text}^{fine} = FC ( {υ}_{text} \cdot 128 ) \qquad [ Equation 6 ]$$

$${υ}_{text}^{middle} = FC ( {υ}_{text} \cdot 64 ) \qquad [ Equation 7 ]$$

$${υ}_{text}^{coarse} = FC ( {υ}_{text} \cdot 64 ) \qquad [ Equation 8 ]$$

In Equations 6 to 8, FC represents the fully connected layer, and vₜₑₓₜ represents the text feature map.

Then, the fusion module 120 may convolve the text feature map that has passed through the fully connected layer and each visual feature map to generate the attention map.

That is, the fusion module 120 may convolve the first text feature map and the first visual feature map to generate the first attention map, convolve the second text feature map and the second visual feature map to generate the second attention map, and convolve the third text feature map and the third visual feature map to generate the third attention map.

This is shown as in Equations 9 to 11.

$${att\_map}^{coarse} = {υ}_{text}^{coarse} * {υ}_{image}^{coarse} \qquad [ Equation 9 ]$$

$${att\_map}^{middle} = {υ}_{text}^{middle} * {υ}_{image}^{middle} \qquad [ Equation 10 ]$$

$${att\_map}^{fine} = {υ}_{text}^{fine} * {υ}_{image}^{fine} \qquad [ Equation 11 ]$$

Here,

$${att\_map}^{coarse} , {att\_map}^{middle} and {att\_map}^{fine}$$

represents each convolution ray, and the sizes of each convolution layer may be different.

Next, the fusion module 120 may sum the first to third attention maps to generate each step attention map. This is shown as in Equation 12.

$${att\_map}^{i} = {att\_map}^{coarse} + {att\_map}^{middle} + {att\_map}^{fine} \qquad [ Equation 12 ]$$

By repeating Equations 4 to 12 multiple times, the plurality of step attention maps may be generated, and aggregated to calculate the final attention map. This is shown as in Equation 13.

$$att\_map \_final = Concatenation ( {att\_map}^{1} , … , {att\_map}^{5} ) \qquad [ Equation 13 ]$$

In an embodiment of the present disclosure, it is assumed that there are five step attention maps, and Equation is defined that the final attention map is generated by aggregating five step attention maps. However, the number of step attention maps may vary according to the implementation method. In such a case, it is obvious that the number of step attention maps to be aggregated may also vary.

The final attention map may be generated by combining the feature map obtained by passing through two convolutional layers and then the LSTM network with the time-step embedding. In this way, the agent may remember hidden objects by utilizing the past hidden state and generate good actions in the future.

The policy learning unit 125 has an asynchronous reinforcement learning model, and may perform navigation by coordinating actions using the final feature map.

The policy learning unit 125 may receive the final feature map and the text feature map of the language-based command (instruction), respectively, as the state input of the asynchronous reinforcement learning model, and train the asynchronous reinforcement learning model to perform appropriate output actions according to the instructions using the received final feature map and text feature map.

An asynchronous reinforcement learning model according to an embodiment of the present disclosure may be a hybrid model that combines imitation learning (IL) and reinforcement learning. According to an embodiment of the present disclosure, the agent may calculate cross entropy loss along a teacher task to perform an exploration along a trajectory, and sample tasks according to task probability at each step to calculate a reward value.

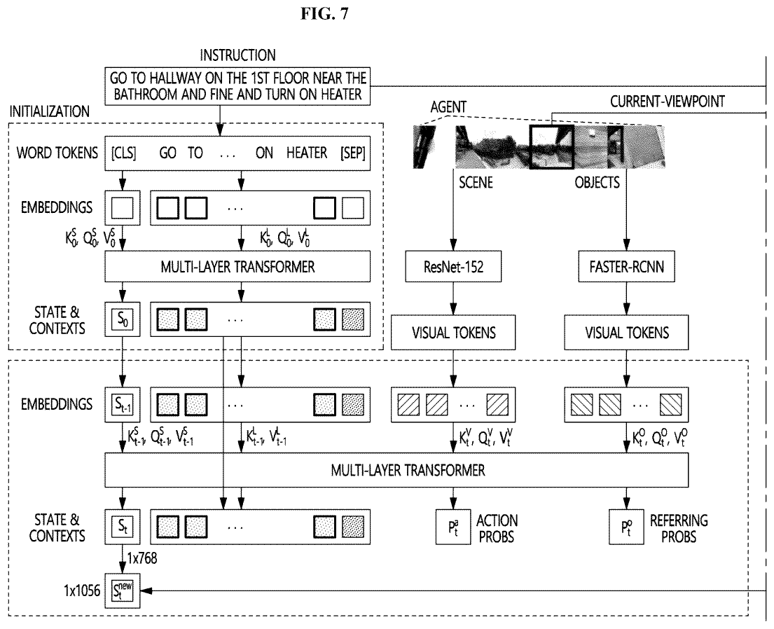

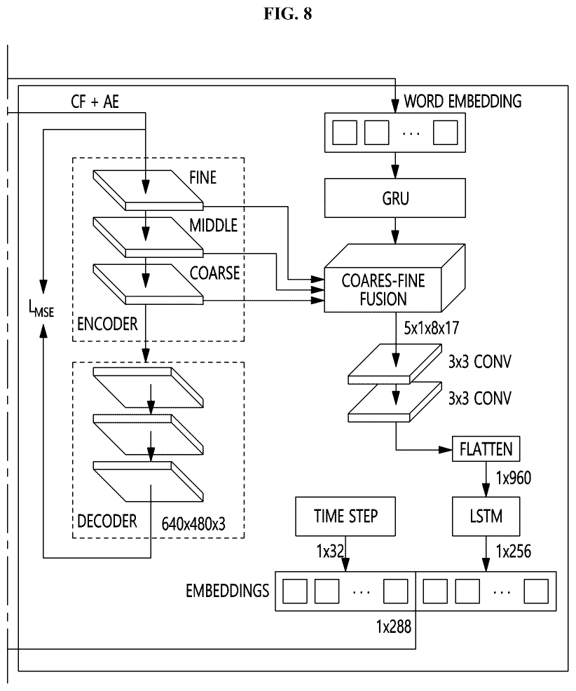

FIG. 7 and FIG. 8 are diagrams illustrating the overall architecture of an experimental setup according to an embodiment of the present disclosure. In the initial process, the instruction may be encoded through a multilayer transformer. Then, an initial state of the agent may be represented by an output feature of a CLS token.

After the instruction and the current point of view (image) are transferred to the first feature extraction module 110 and the second feature extraction module 115, respectively, to extract visual features and text features, respectively, the extracted visual features and text features may be fused to generate the final feature map. This is the same as those described above, and thus the overlapping description thereof will be omitted.

For the navigation in the virtual space, visual tokens may be included in the point of view sequence together with information about the scene and object. The combined sequence of the states and the encoded language may be transferred to the same multilayer transformer to obtain the decision probability.

In order to utilize the useful information for the agent, the final feature map is integrated with the text feature map and used as an input to a critique network of the reinforcement learning model, so the agent may effectively perform the navigation in the given environment.

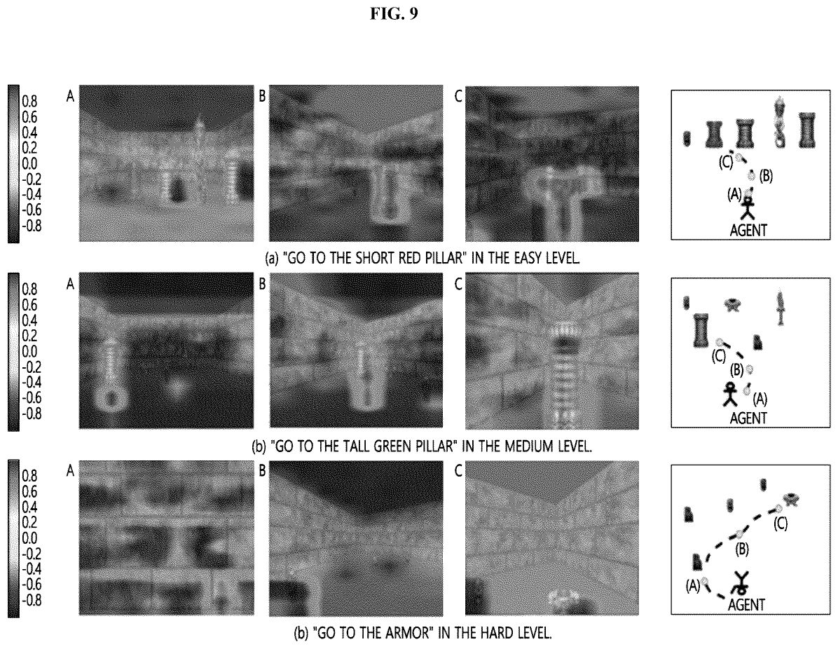

FIG. 9 is a diagram illustrating an attention map overlapping on an input image while an agent performs language-based commands according to an embodiment of the present disclosure. Since the attention map is closely related to an object specified in the command, an object to which attention is paid becomes a target in an embodiment of the present disclosure.

The leftmost part shows an attention scale, and the rightmost part shows a trajectory drawn by an agent while performing the given task. The attention map overlaps the input image that the agent has seen while exploring. FIG. 9A illustrates an easy level case according to the command “Go to the short red pillar”. In this case, the agent may move to a target relatively easily.

In the middle level, according to the command “Go to the tall green pillar”, the agent first approaches a red keycard and then moves to a target object (FIG. 9B).

As illustrated in FIG. 9C, in the case of the difficult level, the process of exploring, by the agent, the target through a long journey for the command “Go to the armor”. It may be confirmed through FIG. 9 that an attention area highlighted in red matches well with a target indicated by text.

The memory 130 stores various commands (program codes) for performing a coarse-to-fine fusion method for virtual space navigation based on language commands according to an embodiment of the present disclosure.

The processor 135 is a means for controlling internal components (e.g., the first feature extraction module 110, the second feature extraction module 115, the fusion module 120, the policy learning unit 125, the memory 130, etc.) of the computing device 100 for performing the coarse-to-fine fusion method for virtual space navigation based on language commands according to an embodiment of the present disclosure.

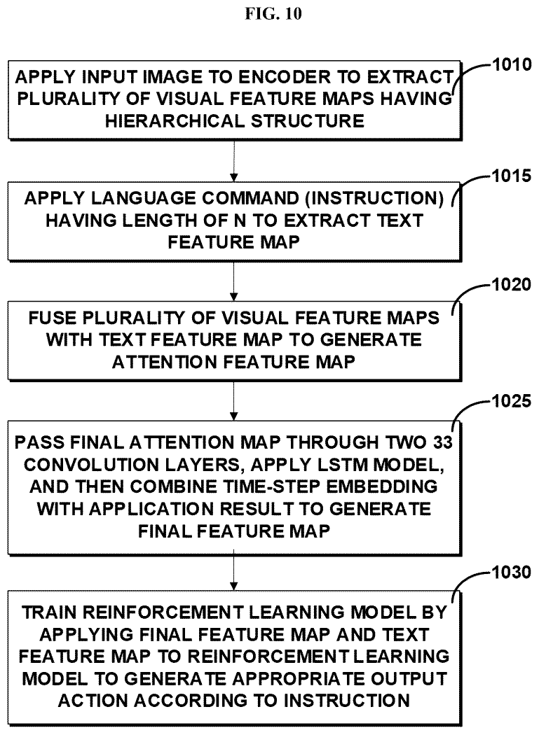

FIG. 10 is a flowchart illustrating the coarse-to-fine fusion method for virtual space navigation based on language commands according to an embodiment of the present disclosure.

In step 1010, the computing device 100 applies an input image to an encoder to extract a plurality of visual feature maps having a hierarchical structure. A decoder may be additionally utilized during the training process of the encoder. The output of the encoder is restored through the decoder, and the mean square error (MSE) between the final output of the decoder and the input image may be calculated and used as a loss function of the encoder.

This is shown as in Equation 14.

$${ℒ}_{MSE} ( x , {x}_{decode} ) = {\sum }_{l}^{l + b \leq n} {\sum }_{i = 1}^{ω} {\sum }_{j = 1}^{h} {( {x}^{l , i , j} - {x}_{decode}^{l , i , j} )}^{2} \qquad [ Equation 14 ]$$

Here, b represents the number of batches, n represents the number of data sets, l belongs to {0, b, 2b, . . . }, w and h represent the width and height of the input image, x represents the input image, and x_{decode} represents the image reconstructed by the decoder.

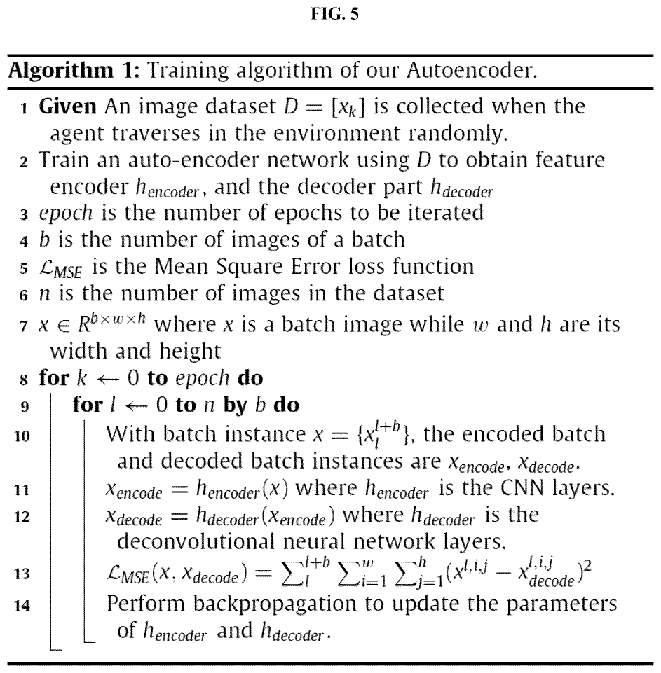

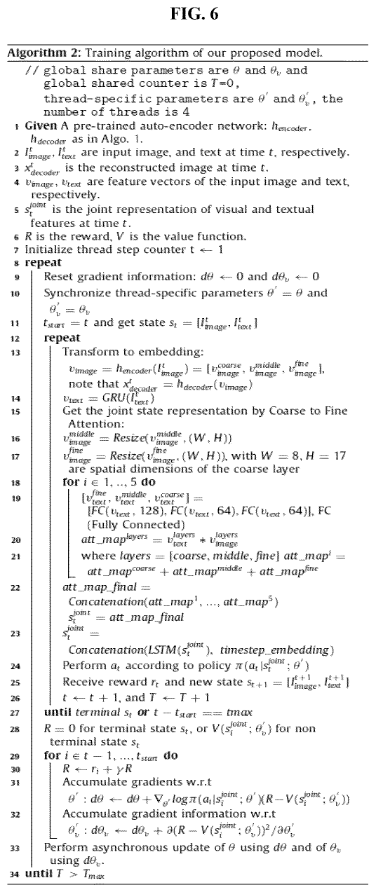

FIG. 4 shows how to train the encoder, and FIG. 5 shows how to train network with the pre-trained encoder.

In step 1015, the computing device 100 applies a language command (instruction) having length of N to a language model to extract a text feature map.

In step 1020, the computing device 100 fuses the plurality of visual feature maps and the text feature maps to generate the attention feature map.

This will be described in more detail.

The computing device 100 may reconstruct a plurality of visual feature maps having different resolutions to the same size. Then, the computing device 100 may perform the convolution operation on each of the plurality of visual feature maps reconstructed to the same size and the resized visual feature map through the fully connected layer to generate the plurality of attention maps, respectively.

The computing device 100 may aggregate the plurality of attention maps to generate the step attention map. This process may be repeated multiple times to generate the plurality of step attention maps, and combine the step attention maps to generate the final attention map.

In step 1025, the computing device 100 passes the final attention map through two 3×3 convolutional layers, applies an LSTM model, and then combines the time-step embedding with the result to generate a final feature map.

In step 1030, the computing device 100 trains the reinforcement learning model by applying the final feature map and the text feature map to the reinforcement learning model to generate an appropriate output action according to the instruction.

The apparatus and the method according to an embodiment of the present disclosure may be implemented in the form of program commands that may be executed through various computer units and be recorded in a computer-readable recording medium. The computer-readable recording medium may include program commands, data files, data structures, or the like, alone or in combination. The program commands recorded in the computer-readable recording medium may be specially designed and constituted for the present disclosure or be known to and usable by those skilled in a computer software field. Examples of the computer-readable recording medium may include magnetic media such as hard disks, floppy disks, and magnetic tapes; optical media such as compact disk read only memories (CD-ROMs) and digital versatile disks (DVDs); magneto-optical media such as floptical disks; and hardware devices specially configured to store and execute program commands, such as ROMs, random access memories (RAMs), and flash memories. Examples of the program commands include high-level language codes capable of being executed by a computer using an interpreter, or the like, as well as machine language codes made by a compiler.

The above-described hardware devices may be constituted to be operated as one or more software modules in order to perform operations of the present disclosure, and vice versa.

Embodiments of the present disclosure have been mainly described hereinabove. It will be understood by those skilled in the art to which the present disclosure pertains that the present disclosure may be implemented in a modified form without departing from essential characteristics of the present disclosure. Therefore, embodiments disclosed herein should be considered in an illustrative aspect rather than a restrictive aspect. The scope of the present disclosure should be defined by the claims rather than the above description, and equivalents to the claims should be interpreted to fall within the present disclosure.

What is claimed is:

1. A coarse-to-fine fusion method for virtual space navigation based on language commands, comprising following steps:
(a) applying an input image to an encoder to extract first to nth visual feature maps having a hierarchical structure;
(b) applying an instruction having a length of N to a language model to extract a text feature map; and
(c) fusing each of the first to nth visual feature maps with the text feature map to generate an attention map.

2. The coarse-to-fine fusion method of claim 1, wherein the step (b) includes following steps:
(b1) reconstructing sizes of the first to nth visual feature maps to be the same;
(b2) performing a convolution operation on the reconstructed first to nth visual feature maps with the text feature map, respectively, to generate first to nth attention maps, respectively, and aggregating the first to nth attention maps to generate a step attention map; and
(b3) performing the steps (b1) to (b2) multiple times to generate a plurality of step attention maps, and combining the plurality of step attention maps to generate a final attention map.

3. The coarse-to-fine fusion method of claim 2, wherein, before performing the convolution operation on each of the reconstructed first to nth visual feature maps with the text feature map, the text feature map is reconstructed to a size of a visual feature map to which the convolution operation is to be applied by applying a fully connected layer.

4. The coarse-to-fine fusion method of claim 2, further comprising:
passing the final attention map through two convolutional layers, applying a long short-term memory (LSTM) model, and then combining time-step embedding to generate a final feature map; and
training a reinforcement learning model by applying a state of the final feature map and the text feature map as input to the reinforcement learning model to generate an output action according to the instruction.

5. A non-transitory computer-readable recording medium in which a program code for performing the coarse-to-fine fusion method according to claim 1 is recorded.

6. A computing device, comprising:
a first feature extraction module that applies an input image to an encoder to extract first to nth visual feature maps having a hierarchical structure;
a second feature extraction module that applies an instruction having a length of N to a language model to extract a text feature map; and
a fusion module that fuses each of the first to nth visual feature maps with the text feature map to generate an attention map.

7. The computing device of claim 6, wherein the fusion module reconstructs sizes of the first to nth visual feature maps to be the same, performs a convolution operation on the reconstructed first to nth visual feature maps with the text feature map, respectively, to generate first to nth attention maps, respectively, and aggregates the first to nth attention maps to generate a step attention map, and
a plurality of step attention maps are generated, and the plurality of step attention maps are combined to generate a final attention map.

8. The computing device of claim 7, wherein before performing the convolution operation on each of the reconstructed first to nth visual feature maps with the text feature map, the text feature map is reconstructed to a size of a visual feature map to which the convolution operation is to be applied by applying a fully connected layer.

9. The computing device of claim 6, wherein the first feature extraction module further includes a decoder used only in a training process, and
a loss function of the encoder is calculated using a mean square error between an output of the decoder and the input image.

10. The computing device of claim 6, wherein two 3×3 convolution layers and a long short-term memory (LSTM) model are located at a rear end of the fusion module, and a final attention map passes through the two 3×3 convolution layers and the LSTM model, and then combines time-step embedding to generate a final map.

11. The computing device of claim 10, further comprising:
a policy learning unit that trains a reinforcement learning model by inputting and applying a state of the final map and the text feature map to the reinforcement learning model to generate an output action according to the instruction.
